(19) United States
(12) Patent Application Publication
(10) Pub. No.: US 2006/0256568 A1
(43) Pub. Date: Nov. 16, 2006

(54) Portable outdoor LED illumination apparatus

(76) Inventor: Mark E. Ellis, White Salmon, WA (US)

Correspondence Address: MARTIN S. HIGH, P.O. BOX 217, STILLWATER, OK, 74076, US

(21) Appl. No.: 11/130,454

(22) Filed: May 16, 2005

(51) Int. Cl. F21S 13/10

(52) U.S. Cl. 362/431

(57) ABSTRACT

The Portable Outdoor LED Illumination Apparatus provides nighttime illumination of an outdoor area for campers and other outdoor enthusiasts. The apparatus includes a vertical, tubular support pole and an illumination head assembly. The vertical, tubular support pole is comprised of a plurality of segments which are connected via springs internal to the segments. The springs allow easy collapse of the vertical, tubular support pole into a transportable unit. The segments, and therefore the vertical tubular support pole, are hollow and allow for an electrical conductor to pass from a compartment housing a plurality of batteries to the illumination head assembly. The illumination head assembly, which is comprised of a plurality of light emitting diodes (“LED's”) fixed within an epoxy potting, is affixed in such a manner so that when the LED's are powered the light is directed in the general direction of the ground.

### CROSS-REFERENCE TO RELATED APPLICATIONS

This application claims the benefit of U.S. Provisional Application No. 60/599,116 filed on Aug. 5, 2004 titled “Portable Outdoor LED Illumination Apparatus.” U.S. Provisional Application No. 60/599,116 is incorporated herein by reference.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF THE INVENTION

1. Field of the Invention

The field of the invention is generally portable outdoor illumination. The invention also relates to illumination of camping, fishing and outdoor sporting and recreational activities. In addition, the invention can be used for landscape illumination when used in conjunction with an external power source.

2. Description of Related Art Including Information Disclosed Under 37 CFR 1.97 and 1.98

There are many applications of outdoor illumination for recreational purposes. When campers and others who spend recreational time outdoors nighttime, illumination of the area to be occupied is commonly required. Before the advent of the instant invention, flashlights, lanterns, fires and candles have been used for illumination purposes. Candles and fires have the obvious disadvantage of creating a potential fire hazard and require an ignition source. Fires also require the purchased or gathering of fuel. Flashlights require the user to hold the light limiting the use of hands in other operations. Flashlights can be mounted on a supporting structure, but this is usually awkward and unstable.

Another solution to the nighttime illumination problem is the use of stands for lanterns. These stands hold a lantern, battery or hydrocarbon fuel powered light source, several feet above the ground to provide sufficient illumination to the surrounding area. U.S. Pat. No. 3,725,696, issued to Morton on Apr. 3, 1973, for a Portable Light Holder for Camper's Gas Lamp, disclosed a light support structure for a camp light. The gas light contemplated in this invention has many of the same drawbacks as using a candle or fire to illuminate the area in that the gas lantern consumes highly flammable hydrocarbon fuel. Furthermore, the light cast by a gas lantern is typically extremely harsh. One of the significant disadvantages of harsh nighttime lighting is that it diminishes the night vision of persons in the area. When the individual attempts to leave the illuminated area, a period of readjustment is required for the eyes in order to function adequately. Further, the harsh light precludes observations outside the illuminated area; the individual can see only within the area in the immediate vicinity of the intense lighting.

U.S. Pat. No. 5,108,05, issued to White on Apr. 11, 1989, disclosed an apparatus to be mounted on a support structure for supporting a light having a bail. The White patent extended the idea of the support structure of Morton by allowing the support structure to be clamped onto a fixed object to support the lantern. White's invention does not eliminate the problems of the Morton invention including that of harsh illumination.

U.S. Pat. No. 6,752,509, issued to Lin on Jun. 22, 2004, discloses an illuminating umbrella grip includes a cassette LED illuminating unit detachably mounted in a holder formed on the umbrella grip. The Lin patent does not address the problem of illuminating an outdoor area, but simply provides a decorative lighting to an umbrella standard.

### BRIEF SUMMARY OF THE INVENTION

It is therefore an object of the invention to provide an improved apparatus for nighttime illumination of an outdoor area for campers and other outdoor enthusiasts. The application to camping is a focus of the instant invention but is not limited in application to camping. In addition, the invention can be used for landscape illumination when used in conjunction with an external power source. The main object of the invention is to provide a floodlight type lighting system for outdoor enthusiasts as opposed to a more targeted light source found in task lighting, such as flashlights.

The instant invention provides an improved apparatus for nighttime illumination of an outdoor area. The apparatus includes a vertical, tubular support pole and an illumination head assembly. The vertical, tubular support pole is comprised of a plurality of segments which are connected via springs internal to the segments. In one preferred embodiment of the instant invention there are three segments: a bottom segment; a middle segment; and a top segment. The springs allow for easy collapse of the vertical, tubular support pole into a transportable unit. The segments, and therefore the vertical tubular support pole, are hollow and allow for an electrical conductor to pass from a compartment housing a plurality of batteries to the illumination head assembly. A toggle joint is located on one end of the segments that are joined to other segments. This toggle joint allows for a secure resistance fit with the end of the other segment that is mated into the toggle joint. Extended into the toggle joint and into the end opening of the other hollow segment is a toggle joint to allow for ease in assembly and disassembly and the electrical conductor that runs from the batteries powering the light to the illumination head assembly. The lowest segment of the vertical, tubular support pole contains a chamber that houses the plurality of batteries. The illumination head assembly is comprised of a plurality of light emitting diodes (“LED's”) fixed within an epoxy potting. The plurality of LED's are affixed in the illumination head assembly in such a manner so that when the LED's are powered to emit light, the light is directed in the general direction of the ground. The segments, and therefore the vertical, tubular support pole, are hollow and allow for an electrical conductor to pass from a compartment housing a plurality of batteries to the illumination head.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWING

FIG. 1a is a bottom view of the illumination head assembly.

FIG. 1b is a side view of the illumination head assembly.

FIG. 2 is an overall side view of the Portable Outdoor LED Illumination Apparatus.

FIG. 3 is a side view of one of the joints connecting to of the segments of the vertical, tubular support pole in its assembled position.

FIG. 4a is a side view showing one of the joints connecting to of the segments of the vertical, tubular support pole in its disassembled position.

FIG. 4b is a top view showing one of the joints connecting to of the segments of the vertical, tubular support pole in its disassembled position. The spring is not shown in this figure.

FIG. 4c is a side view showing one of the joints connecting to of the segments of the vertical, tubular support pole in its disassembled position. The spring is only partially shown.

FIG. 5 is a view of the toggle joint.

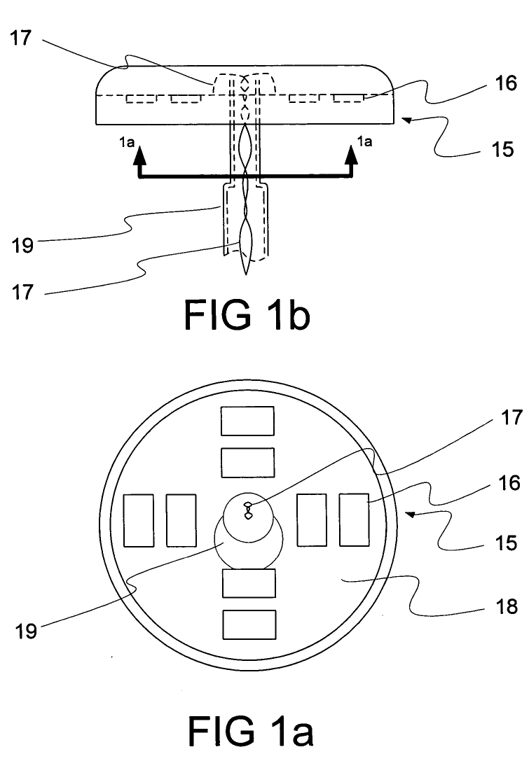

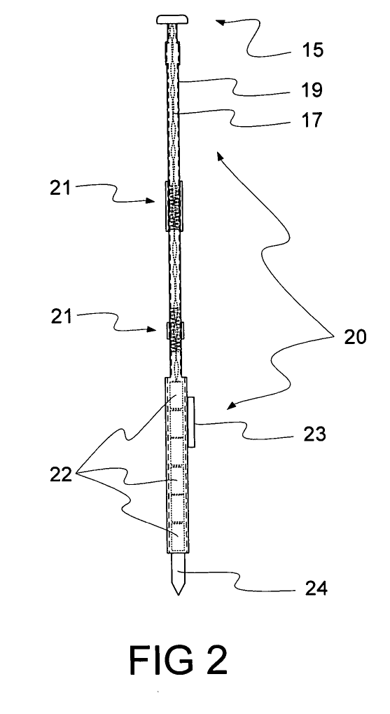

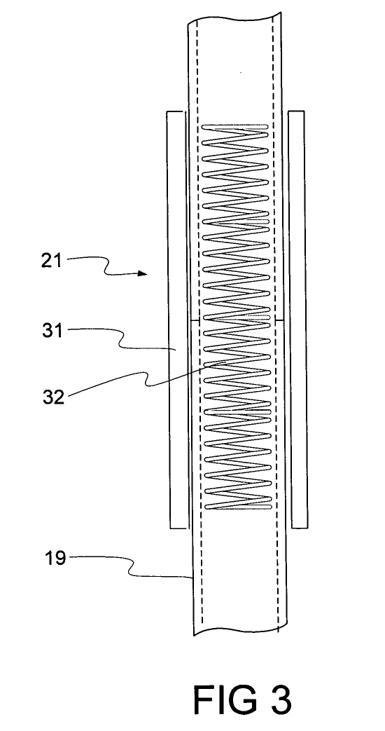

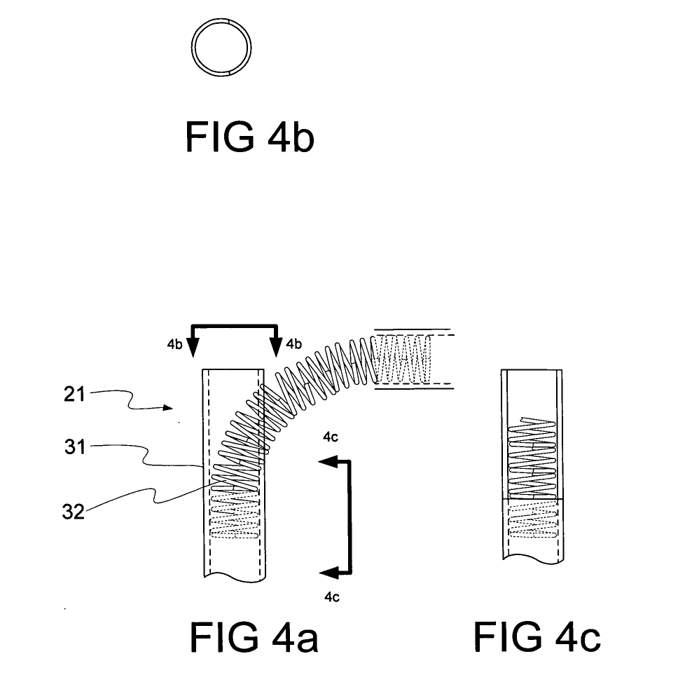

### DETAILED DESCRIPTION OF THE INVENTION

### 1. Detailed Description and Embodiments

It is an object of the instant invention to provide an improved apparatus for nighttime illumination of an outdoor area. The apparatus, the Portable Outdoor LED Illumination Apparatus 20, includes a vertical, tubular support pole 19 and an illumination head assembly 15. The vertical, tubular support pole 19 is comprised of a plurality of segments which are connected via toggle joints 21 which terminate the segments. The toggle joints 21 allow easy collapse of the vertical, tubular support pole 19 into a more transportable unit, but maintain the segments in the order of assembly even when the invention is collapsed. The segments, and therefore the vertical, tubular support pole 19, are hollow and allow for an electrical conductor 17 to pass from a compartment housing a plurality of batteries 22 to the illumination head. The lowest segment of the vertical, tubular support pole 19 contains a chamber that houses the plurality of batteries 22. The illumination head assembly 15 is comprised of a plurality of light emitting diodes 16 (“LED's”) fixed within an epoxy potting 18. The plurality of LED's 16 are affixed in the illumination head assembly 15 in such a manner so that when the LED's 16 are powered to emit light, the light is directed in the general direction of the ground. In one embodiment of the invention six (6) LED's 16 are used in the invention. In another embodiment, eight (8) LED's are used. In yet another embodiments, the illumination head assembly 15 can be removed from the vertical, tubular support pole 19 detached from the electrical connection, and an alternative illumination head assembly 15 can be installed with a different number of LED's than previously installed. Further, the color of light generated can be altered by installing a different illumination head assembly 15. This allows different types of task lighting to be used for different purposes. For example, a red illumination head assembly could be used by amateur or professional astronomers so that their night vision is not harmed by white illumination systems. In addition, the invention can be used for landscape illumination when used in conjunction with an external power source.

Again, the toggle joints 21 allow easy collapse of the instant invention into a more transportable unit. The toggle joints 21 are comprised of a toggle joint 31 that is permanently affixed to one end of each segment that connect to other segments, and, when assembled, accepts the end of a second vertical, tubular support pole segment thereby forming a longer pole segment. The appropriate ends of the pole segments are held in place by the toggle joint 31 via a resistance fit within the toggle joint 31. A spring 32 is housed within the ends of the tubular support pole segments. Each end of the spring 32 is affixed to the inside walls of the tubular support pole segments so that when the toggle joints 21 are disassembled the tubular support pole segments remain loosely connected via the springs 32. This allows the tubular support pole 19 to be disassembled into a more transportable form, but yet the segments are connected via springs to the associated mated segment to allow for ease in reassembly. In a preferred embodiment of the instant invention, the entire vertical, tubular support pole 19 is formed via two toggle joints 21. In another preferred embodiment of the instant invention, the entire vertical, tubular support pole 19 is formed via three toggle joints 21.

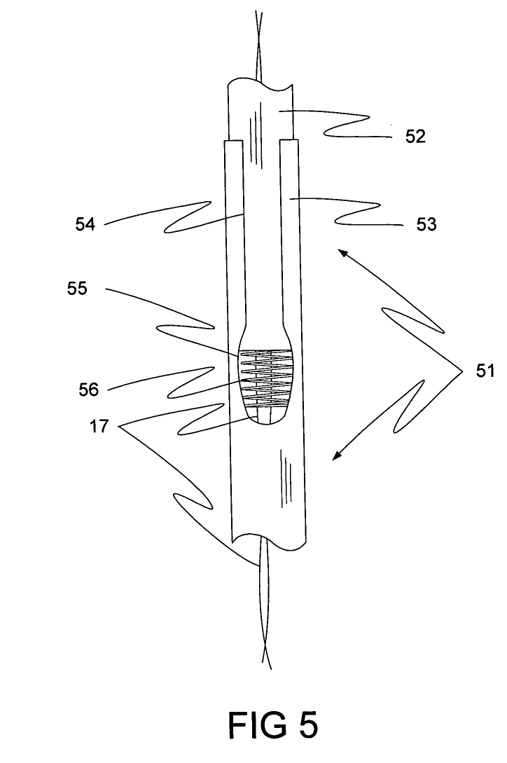

Another preferred embodiment of the toggle joint 51 is shown in FIG. 5. In this embodiment, a top tube 52 is held in place by friction fit within a bottom tube 53. Electrical connections 17 pass through the toggle joints 51 in the hollow annular opening formed by the top tube 52 and bottom tube 53. A spring 56 is located inside both the bottom tube 53 and the top tube 52. The spring 56 is held inside the bottom tube 53 and the top tube 52 through a resistance fit or through use of an adhesive means. The bottom tube 53 forms a toggle opening that is comprised of a top linear opening 54 and a bottom opening 55. The top linear opening 54 and the bottom opening 55 are joined to form the toggle opening. The bottom opening 55 is an elongated oval shape with a rounded end and opposite the end that joins with the top linear opening 54. The top linear opening 54 is formed by parallel sides that extend from the junction with the bottom opening 55 to the top of the bottom tube 53.

The shape of the toggle opening forms a unique function in assembly and disassembly of the top 52 and bottom tubes 53. In disassembly, as the top tube 52 is removed from the bottom tube 53 laterally, the top linear opening 54 expands a small amount thereby allowing the top tube 52 to pass through the top linear opening 54. As the top linear opening 54 expands, the bottom opening 55 also expands, but to a lesser degree. On assembly, the process is reversed. The shape of the top linear opening 54 and bottom opening 55 provides a secure fit upon assembly. The expansion of the top linear opening 54 and bottom opening 55 provides for a toggle, or snap fit, when the top tube 52 is assembled or removed from the bottom tube 53. The electrical connections 17 function as a ‘ligament’ much like in a bone joint in that it is held tight at each end and stabilizes the joint and prevents distortion during the folding. The spring 56 serve to keep the bottom tube 53 and the top tube 52 together and organized when disassembled.

The instant invention also comprises an electric switch which interrupts the electrical power between the plurality of batteries 22 and the plurality of light emitting diodes 16. A ground spike 24 is attached to the bottom segment and is used to place the instant invention into the ground.

### 2. Operation

The operation of the Portable Outdoor LED Illumination Apparatus for use in outdoor recreational activities involves first installing batteries into the device. Then the tubular support pole 19 is assembled by placing the appropriate ends of the segments, which are loosely connected via a spring 32, into the appropriate toggle joints 21 or 51 via a resistance fit. The instant invention is then placed into the ground using the ground spike 24. When the user requires illumination, the electrical switch is engaged so that electrical power flows to the light emitting diodes 16 in the illumination head assembly 15.

The illumination head assembly 15 is supported by the tubular support pole 19 between 4 and 7 feet above the ground, the light emanating from light emitting diodes 16 is directed generally downward and outward from the light emitting diodes 16. The power consumed by the light emitting diodes 16 allows for approximately 20 hours of operation, and depending on the quality of the batteries used operation of in excess of 20 hours is likely. The instant invention provides a floodlight type lighting system for outdoor enthusiasts in the area of the invention.

The instant invention can also be used in the collapsed configuration. A small clamp is used to attached the invention to a structure such as, but not limited to, a boat seat, table or picnic seat. The electrical switch is engaged so that electrical power flows to the light emitting diodes 16 in the illumination head assembly 15 to provide floodlight type lighting. The instant invention is particularly novel given the use of new, bright-white LED technology, the portability and compactness of the device when disassembled and collapsed, the versatility of uses, and the light weight compared to other inventions.

What is claimed is:

1. An outdoor illumination device comprising
a) a vertical, segmented, tubular support pole, and
b) an illumination assembly located at the top of the support pole.

2. An outdoor illumination device as described in claim 1 further comprising
a) a plurality of light emitting diodes housed in the illumination assembly, and
b) toggle joints.

3. An outdoor illumination device as described in claim 2 where the vertical, segmented, tubular support pole is further comprised of
a) a plurality of individual segments;
b) the plurality of individual segments is further comprised of
i) a bottom segment;
ii) a middle segment;
iii) a top segment; and
c) the bottom segment forms a hollow annular chamber.

4. An outdoor illumination device as described in claim 3 further comprised of
a) a toggle joint that is permanently affixed to one end of each segment that connect to other segments;
b) a spring housed within the ends of the tubular support pole segments

5. An outdoor illumination device as described in claim 4 further comprised of
a) a plurality of batteries housed in the hollow annular chamber; and
b) an electrical connection between the plurality of batteries and the plurality of light emitting diodes.

6. An outdoor illumination device as described in claim 5 that is further comprised of a clamp attached to the bottom segment used to attached the outdoor illumination device to a structure.

7. An outdoor illumination device as described in claim 6 where the plurality of individual segments is manufactured from polymeric materials, metal, wood, or a composite material.

8. An outdoor illumination device as described in claim 7 where the plurality of individual segments is manufactured from polycarbonate.

9. An outdoor illumination device as described in claim 8 where the plurality of individual segments is comprised of two segments.

10. The method of outdoor illumination using
a) a vertical, segmented, tubular support pole, and
b) an illumination assembly located at the top of the support pole.

11. A toggle joint comprising
a) a top tube which forms a longitudinal annular opening;
b) a bottom tube which forms a longitudinal annular opening;
c) a spring placed inside both the bottom tube and the top tube;
d) the bottom tube forms a toggle opening that provides a resistance fit to the top tube as the top tube is removed and inserted laterally.

12. The toggle joint as described in claim 11 where the toggle opening is further comprised of
a) a top linear opening and;
b) a bottom opening;
c) where the top linear opening and the bottom opening are joined to form the toggle opening.

13. The toggle joint as described in claim 12 where
a) the bottom opening is an elongated oval shape with a rounded end opposite the end that joins with the top linear opening;
b) the top linear opening is formed by parallel sides that extend from the junction with the bottom opening to the top of the bottom tube.

14. The toggle joint as described in claim 13 where the spring is held inside the bottom tube and the top tube through a resistance fit or through use of an adhesive means.
